(19) United States
(12) Patent Application Publication
(10) Pub. No.: US 2010/0177334 A1
(43) Pub. Date: Jul. 15, 2010

(54) Information processing apparatus and storage medium storing printer driver program

(75) Inventor: Yoshito Nishihara, Chiba (JP)

Correspondence Address: Harness, Dickey & Pierce P.L.C., P.O. Box 8910, Reston, VA, 20195, US

(73) Assignee: RICOH COMPANY, LTD.

(21) Appl. No.: 12/654,747

(22) Filed: Dec. 30, 2009

(30) Foreign Application Priority Data
Jan. 13, 2009 (JP) 2009-005085

(51) Int. Cl. G06F 3/12

(52) U.S. Cl. 358/1.13

(57) ABSTRACT

A computer-readable storage medium storing a printer driver program is disclosed. The printer driver program causes a computer to draw and display a printer configuration image. The printer driver program includes an optional accessory information obtaining code unit for obtaining optional accessory information on optional accessories attached to a printer; a storage code unit for storing a printer image, optional accessory images, and image layout information including intermediate optional accessory information indicating optional accessories placeable between each optional accessory and the printer; an order determining code unit for determining an order of drawing the optional accessory images based on the optional accessory information and the intermediate optional accessory information; and a configuration image drawing code unit configured to draw the printer configuration image by arranging the optional accessory images relative to the printer image according to the determined order and the image layout information.

### BACKGROUND OF THE INVENTION

1. Field of the Invention

A certain aspect of the present invention relates to an information processing apparatus and a storage medium storing a printer driver program.

2. Description of the Related Art

A printer driver is a program installed, for example, in a user terminal and sends a print request including print settings to a printer. A printer driver may also have a function to visually display information related to a printer such as optional accessories attached to the printer and paper-feed and paper-catch trays to be used via a graphical user interface (GUI). FIG. 1 is a drawing illustrating an exemplary printer properties screen (print setting screen) of a printer driver. The user can specify print options such as the paper size, color/monochrome printing, and duplex printing on the printer properties screen displayed on a user terminal.

Normally, various optional accessories (functions) are available for a printer. Such optional accessories are added to the standard configuration of a printer to add desired functions. For example, to add a stapling function, a punching function, and a binding function (sorting and binding function) to a printer, the corresponding optional hardware accessories are attached to a main unit of the printer (hereafter a main unit of a printer may be simply called a printer). In FIG. 1, an image (hereafter called a configuration image or a printer configuration image) showing a printer configuration including a printer and optional accessories attached to the printer is displayed on the printer properties screen. Thus, a printer driver may include a function to visually display a printer configuration including attached optional accessories to improve user-friendliness.

Related technologies include a method for obtaining a list of available functions of a printer and reporting the available functions to the user (see, for example, patent document 1). In the method, statuses of the functions displayed on a display unit are dynamically changed based on function information to allow the user to easily determine the statuses of the functions when printing.

The optional accessory configuration (configuration of attached optional accessories or functions) varies from printer to printer and may be changed from the initial configuration as needed. Therefore, a printer driver preferably includes a function to obtain current optional accessory configuration information (or function information) and to display a current printer configuration including attached optional accessories on a printer properties screen based on the obtained optional accessory configuration information.

In the related art, configuration images representing various printer configurations to be displayed on the printer properties screen are included in the printer driver. In other words, a related-art printer driver for a printer includes configuration images corresponding to all possible combinations of optional accessories that can be attached to the printer.

The reasons why a printer driver has to include configuration images corresponding to all possible combinations of optional accessories are described below.

Optional accessories may be attached to a printer in various combinations, and relative positions of a combination of optional accessories are determined according to their functions. For example, a binder (sorting and binding function) and a stapler must be arranged in the order mentioned in a direction away from the printer. This is because printed paper sheets output from the printer must be stapled together by the stapler after they are sorted and bound by the binder. In other words, it is not possible to staple the paper sheets together before being processed by the binder. Thus, the order (or relative positions in a direction away from the printer) of optional accessories varies depending on the combination of the optional accessories. For this reason, a related-art printer driver includes configuration images corresponding to all possible combinations of optional accessories. Such a printer driver, after obtaining optional accessory configuration information, uniquely identifies a configuration image corresponding to the optional accessory configuration information from multiple configuration images.

Meanwhile, as a simpler method, it is conceivable to provide one image for each optional accessory and to display a printer configuration by arranging images of optional accessories according to optional accessory configuration information including order information (information about the order of the optional accessories). However, optional accessory configuration information (or function information) provided by the printer does not include order information. In other words, optional accessory configuration information includes only information regarding optional accessories (e.g., names of optional accessories) attached to the printer. One reason for this (optional accessory configuration information does not include order information) is the limitations of the printer. Another reason is to enable the user to manually specify optional accessories (for example, via check boxes under “Options” shown in FIG. 1) even before the printer is installed (i.e., without communicating with the printer). When optional accessories are specified manually, a configuration image corresponding to the specified optional accessories is simply selected from stored configuration images and displayed on the screen. Also in the related art, having configuration images corresponding to all possible combinations of optional accessories is necessary to properly display a tray-pointing image (e.g., an arrow as shown in FIG. 1) for pointing at a paper-feed tray or a paper-catch tray to be used.

FIG. 2 is a drawing illustrating a related-art method of displaying a configuration image. In this related-art method, for each optional accessory, multiple images corresponding to possible positions of the optional accessory are provided.

In FIG. 2, it is assumed that optional accessories A and B are available for a printer and the optional accessories A and B are attached to the left side of the printer. In this case, as shown in FIG. 2, two images of the optional accessory A are necessary for a case where only the accessory A is attached and a case where both of the accessories A and B are attached. With this method, as the number of combinations of optional accessories increases, the number of necessary images and the amount of data including conditions for displaying the images increase. Possible combinations of the printer and the optional accessories A and B are shown below.

(Combination 1) optional accessory A+printer
(Combination 2) optional accessory B+printer
(Combination 3) optional accessory A+optional accessory B+printer

FIGS. 3A and 3B are drawings illustrating a related-art method of displaying an arrow image for pointing at a paper-catch tray. In the related-art method, coordinates of a tray (paper-catch tray or paper-feed tray) indicating the position where an arrow image is displayed are defined for each combination of the printer and the optional accessories (i.e., each drawn configuration image).

Assuming that the optional accessory A of the printer shown in FIG. 2 has a paper-catch tray A, two sets of coordinates are necessary to position an arrow image for pointing at the paper-catch tray A. Accordingly, with this method, the amount of coordinate information necessary to position a tray-pointing image increases as the number of combinations of optional accessories increases.

For example, let us assume that five optional accessories A, B, C, D, and E with different widths are available for a printer and the optional accessories can be attached to the printer in any combination in alphabetical order. In this case, 16 images are necessary only for the optional accessory A and if the optional accessory A has a paper-catch tray, 16 sets of coordinates are necessary to position an image for pointing at the paper-catch tray. Thus, as the number of combinations of optional accessories increases, the amount of necessary information increases exponentially.

As described above, with related-art methods, the amount of necessary information increases exponentially as the number of combinations of optional accessories increases, and this in turn increases the workload of a developer in preparing configuration images and coordinate information. In the case of a common printer driver supporting multiple printer models, the workload of a developer further increases because it is necessary to prepare information for the multiple printer models. This also indicates that the amount of information (particularly image data) to be included in a printer driver increases.

[Patent document 1] Japanese Patent Application Publication No. 2004-326603

### SUMMARY OF THE INVENTION

An aspect of the present invention provides a computer-readable storage medium storing a printer driver program for causing a computer to draw and display a printer configuration image showing a printer configuration including a printer and optional accessories attached to the printer. The printer driver program includes an optional accessory information obtaining code unit configured to obtain optional accessory information on the optional accessories attached to the printer; a storage code unit configured to store a printer image of the printer, optional accessory images corresponding one-to-one to the optional accessories, and image layout information including intermediate optional accessory information provided for each of the optional accessories and indicating optional accessories placeable between each of the optional accessories and the printer; an order determining code unit configured to determine an order of drawing the optional accessory images in a direction away from the printer based on the optional accessory information and the intermediate optional accessory information; and a configuration image drawing code unit configured to draw the printer configuration image by arranging the optional accessory images relative to the printer image according to the determined order and the image layout information.

Another aspect of the present invention provides an information processing apparatus for drawing and displaying a printer configuration image showing a printer configuration including a printer and optional accessories attached to the printer. The information processing apparatus includes an optional accessory information obtaining unit configured to obtain optional accessory information on the optional accessories attached to the printer; a storage unit configured to store a printer image of the printer, optional accessory images corresponding one-to-one to the optional accessories, and image layout information including intermediate optional accessory information provided for each optional accessory and indicating optional accessories placeable between the optional accessory and the printer; an order determining unit configured to determine an order of drawing the optional accessory images in a direction away from the printer based on the optional accessory information and the intermediate optional accessory information; and a configuration image drawing unit configured to draw the printer configuration image by arranging the optional accessory images relative to the printer image according to the determined order and the image layout information.

### BRIEF DESCRIPTION OF THE DRAWINGS

FIG. 1 is a drawing illustrating an exemplary printer properties screen of a printer driver; FIG. 2 is a drawing illustrating a related-art method of displaying a configuration image;

FIGS. 3A and 3B are drawings illustrating a related-art method of displaying an arrow image for pointing at a paper-catch tray;

FIG. 4 is a drawing illustrating a network according to an embodiment of the present invention;

FIG. 5 is a block diagram illustrating a hardware configuration of a PC 1;

FIG. 6 is a block diagram illustrating a functional configuration of the PC 1;

FIGS. 7A through 7E are drawings illustrating a printer image, optional accessory images, and image layout information stored in a storage unit;

FIG. 8 is a drawing showing examples of information used to determine relative positions of devices illustrated in images;

FIG. 9 is a flowchart showing a configuration image display process performed by the PC 1 according to an embodiment of the present invention;

FIG. 10 is a flowchart showing a process of determining the order of drawing optional accessory images based on intermediate optional accessory information;

FIG. 11 is a drawing illustrating images arranged in a determined order;

FIG. 12 is a drawing showing a drawing area where a printer image is drawn;

FIG. 13 is a drawing showing a drawing area where an optional accessory C image is drawn;

FIG. 14 is a drawing showing a drawing area where an optional accessory B image is drawn;

FIG. 15 is a drawing showing a drawing area where an optional accessory A image is drawn;

FIG. 16 is a drawing showing a tray-pointing image drawn in an optional accessory image; and

FIG. 17 is a drawing illustrating a printer properties screen where a drawn printer configuration image is displayed.

### DESCRIPTION OF THE PREFERRED EMBODIMENTS

Preferred embodiments of the present invention are described below with reference to the accompanying drawings.

### <System Configuration>

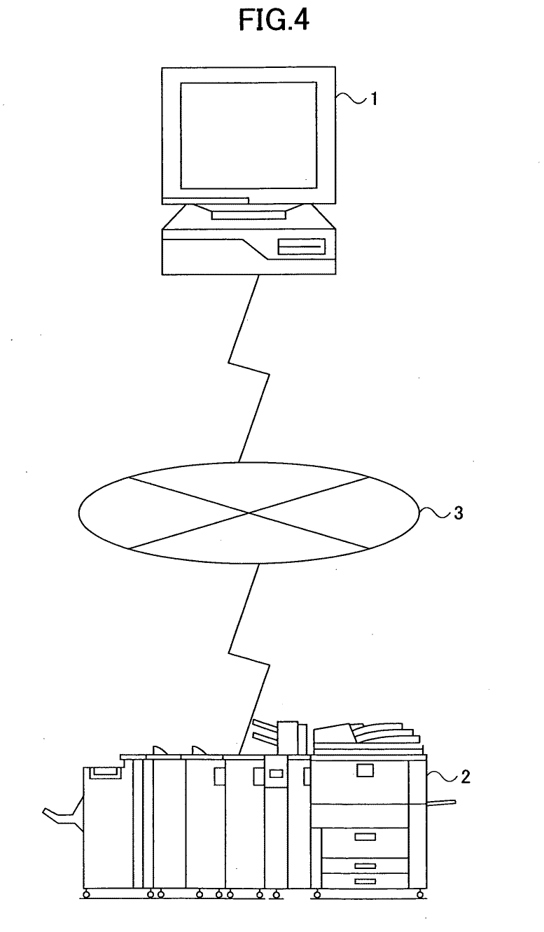

First, a printing environment (or system configuration) according to an embodiment of the present invention is described. FIG. 4 is a drawing illustrating a network according to an embodiment of the present invention. As shown in FIG. 4, a PC (information processing apparatus) 1 and a printer 2 are connected via a network 3. The PC 1 is a personal computer or a user terminal including a printer driver according to an embodiment of the present invention. The printer 2 is an image forming apparatus for forming an image according to a print request from the printer driver of the PC 1. As described later, when the user manually specifies optional accessories, the PC 1 is not necessarily connected to the network 3 to display a printer configuration image by the printer driver, i.e., the PC 1 can be used in stand-alone.

### (PC)

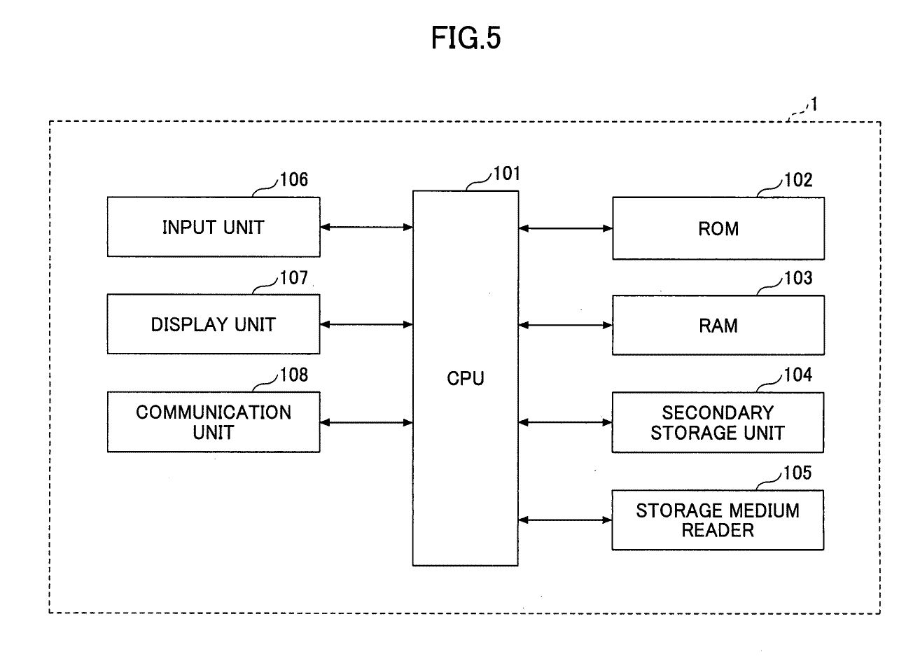

FIG. 5 is a block diagram illustrating a hardware configuration of the PC 1. The PC 1 may be implemented by a common user terminal and includes a CPU 101, a read only memory (ROM) 102, a random access memory (RAM) 103, a secondary storage unit 104, a storage medium reader 105, an input unit 106, a display unit 107, and a communication unit 108.

The CPU 101 is circuitry including a microprocessor and its peripheral circuits and controls the entire PC 1. The ROM 102 is a memory for storing control programs (software components) to be executed by the CPU 101. The RAM 103 is a memory used as a work area by the CPU 101 when performing various control processes by executing the control programs (software components) stored in the ROM 102.

The secondary storage unit 104 is a device for storing various data including a general-purpose operating system (OS) and a printer driver program and may be implemented by a non-volatile storage such as a hard disk drive (HDD). The various data may instead be stored in a storage medium such as a compact disk read-only memory (CD-ROM) or a digital versatile disc (DVD). In this case, a storage medium storing various data including a printer driver program is set in a drive unit such as the storage medium reader 105 to read the data into the PC 1.

The input unit 106 is used by the user to perform various operations. The input unit 106, for example, includes a mouse, a keyboard, and a touch panel switch placed over a display screen of the display unit 107. The display unit 107 displays, for example, a printer properties screen (print setting screen) and a printer configuration image generated by a printer driver on the display screen. The display unit 107 may be implemented by a liquid crystal display (LCD) or a cathode ray tube (CRT) display. The communication unit 108 communicates with the printer 2 via the network 3 and is able to communicate via various types of networks including wired and wireless networks.

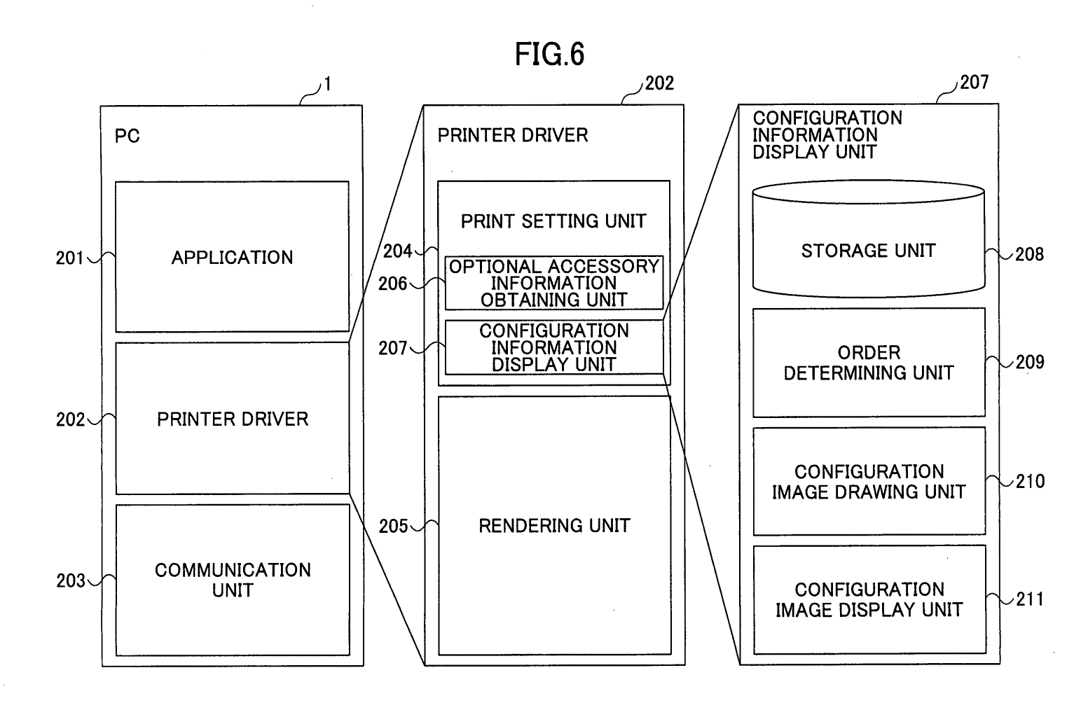

FIG. 6 is a block diagram illustrating a functional configuration of the PC 1. The PC 1 includes an application 201 such as a word processor, a printer driver 202 of this embodiment, and a communication unit 203 for communicating with a printer. The printer driver 202 includes a print setting unit 204 for receiving print settings specified by the user and a rendering unit 205 for converting print data from an application into a format that can be interpreted by a printer. The print setting unit 204 includes, in addition to a function for making print settings, an optional accessory information obtaining unit 206 for obtaining information on optional accessories attached to a printer and a configuration information display unit 207 for displaying printer configuration information including configuration information (text) and a configuration image. The configuration information display unit 207 includes, in addition to a function to display the configuration information (text), a storage unit 208, an order determining unit 209, a configuration image drawing unit 210, and a configuration image display unit 211.

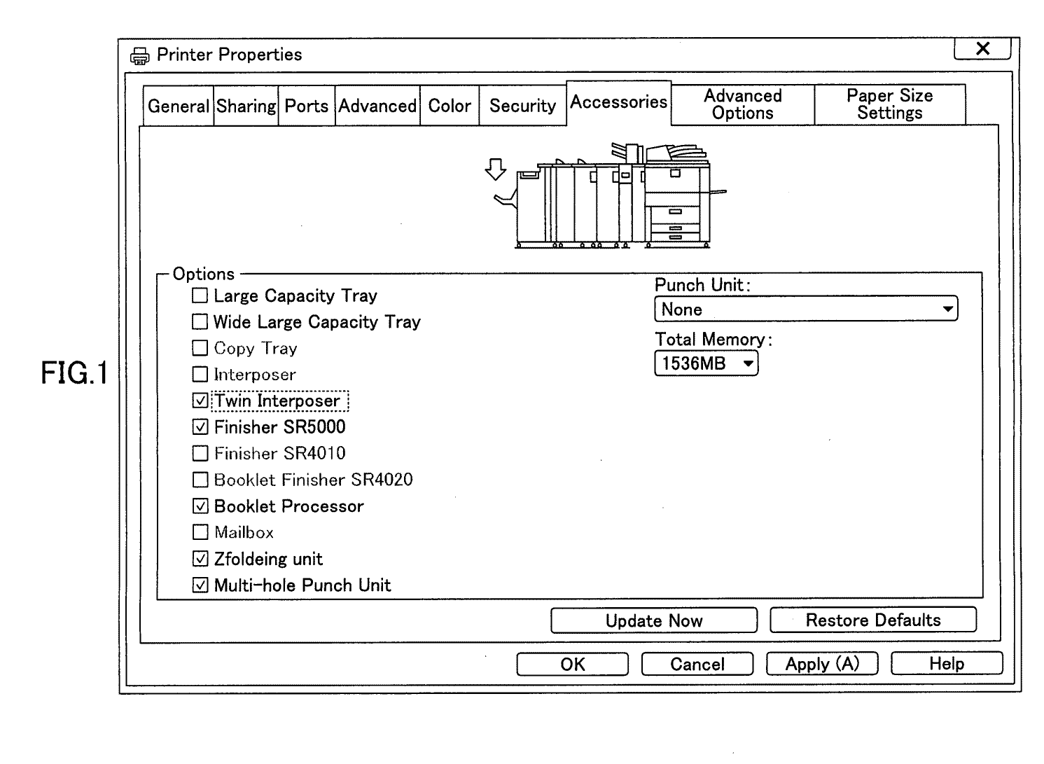

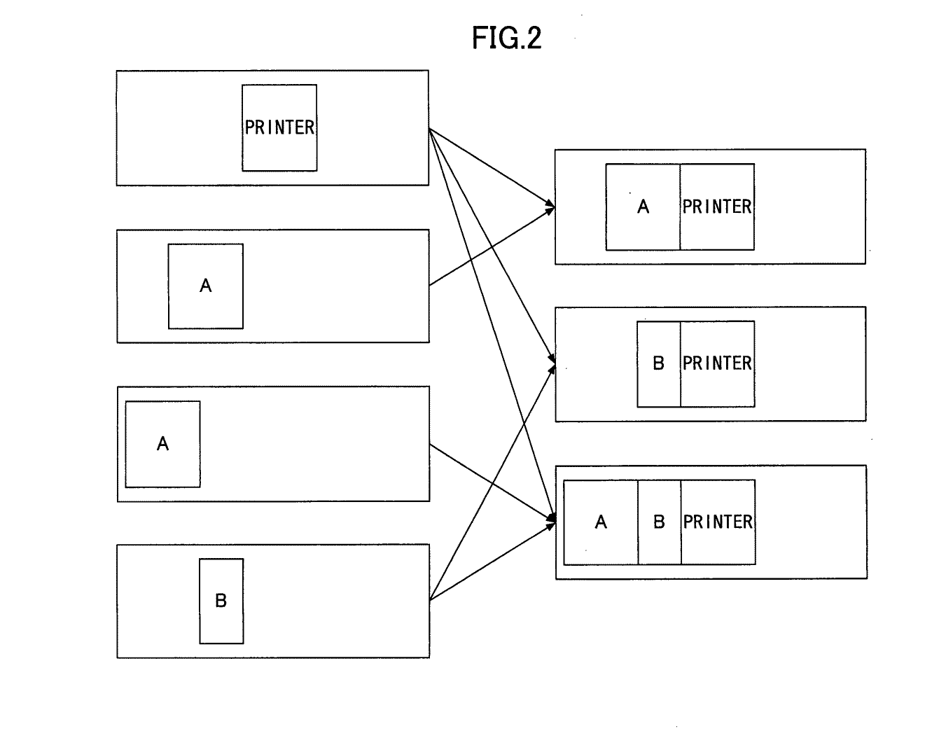

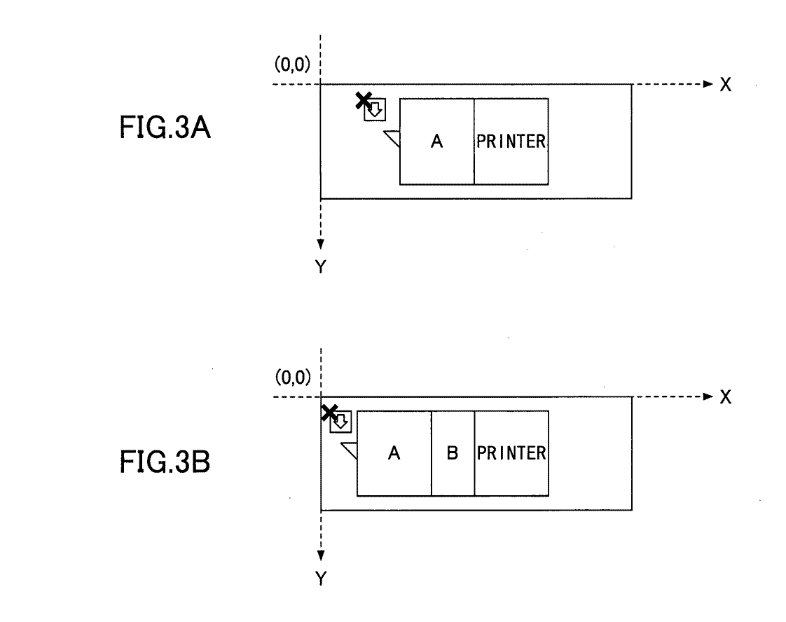

The optional accessory information obtaining unit 206 obtains information on optional accessories attached to a printer, and also obtains information on a tray (paper-catch tray or paper-feed tray) to be used when the optional accessories are attached (hereafter, such information items may be collectively called optional accessory information). For example, the optional accessory information obtaining unit 206 obtains optional accessory information such as “Optional accessory A and optional accessory B are attached to the printer and a paper-catch tray of optional accessory A is used”. The optional accessory information obtained by the optional accessory information obtaining unit 206 does not include other information such as the order in which optional accessories are attached. The optional accessory information obtaining unit 206 obtains the optional accessory information, for example, from the printer 2 via the network 3 or from “Options” settings specified manually by the user on the printer properties screen (see FIG. 1). This is described later in more detail. In any case, the optional accessory information obtaining unit 206 obtains optional accessory information including information on optional accessories attached to the printer and information on a tray to be used.

The storage unit 208 stores a printer image, optional accessory images of respective optional accessories, and image layout information provided for each image. The image layout information provided for the optional accessory images includes intermediate optional accessory information. The intermediate optional accessory information indicates optional accessories that can be placed between the printer and the corresponding optional accessory. The printer image represents a printer (printer main unit). The optional accessory images represent optional accessories, whereby one optional accessory image is provided for each optional accessory. The image layout information also includes coordinate information used when drawing the corresponding image. Details of the intermediate optional accessory information are described later.

The storage unit 208 also stores images for pointing at trays, and the image layout information may further include tray position information indicating the position of a tray provided on the corresponding optional accessory.

The order determining unit 209 determines the order in which optional accessory images are to be drawn in a direction away from the printer (image) based on the optional accessory information obtained by the optional accessory information obtaining unit 206 and the intermediate optional accessory information stored in the storage unit 208. In other words, the order determining unit 209 determines the order of optional accessories attached to the printer.

The configuration image drawing unit 210 draws a printer configuration image by arranging optional accessory images stored in the storage unit 208 with respect to the printer image according to the order determined by the order determining unit 209 and the image layout information stored in the storage unit 208.

Also, based on tray information on a tray to be used and tray position information of the tray, the configuration image drawing unit 210 draws a tray-pointing image for pointing at the tray in the printer configuration image. This is described later in more detail.

The configuration image display unit 211 displays the printer configuration image drawn by the configuration image drawing unit 210 on, for example, the printer properties screen (print setting screen).

The above described functional units are implemented by a printer driver program executed by the CPU 101 of the PC 1.

### (Printer)

The printer 2 is, for example, a multifunction peripheral (MFP) including functions of a printer, a copier, and a scanner. Various optional accessories can be attached to the printer 2. With improved CPU performance, high-capacity memories, high-speed communication technologies, advanced digital imaging technologies, and advanced MFP-related technologies, an up-to-date digital MFP provides functions for sending and receiving data such as images and documents via a network (including e-mail) and facsimile in addition to the above described functions of a digital copier and therefore has a wide range of applications. Details of the configuration of the printer 2 are omitted here.

### <Stored Information Items>

Before describing operations of the PC 1 implemented by a printer driver program of this embodiment, details of information items stored in the storage unit 208 are described. As described above, the storage unit 208 stores a printer image, optional accessory images of respective optional accessories, and image layout information provided for each image. The image layout information may include intermediate optional accessory information indicating optional accessories that can be placed between the printer and the corresponding optional accessory.

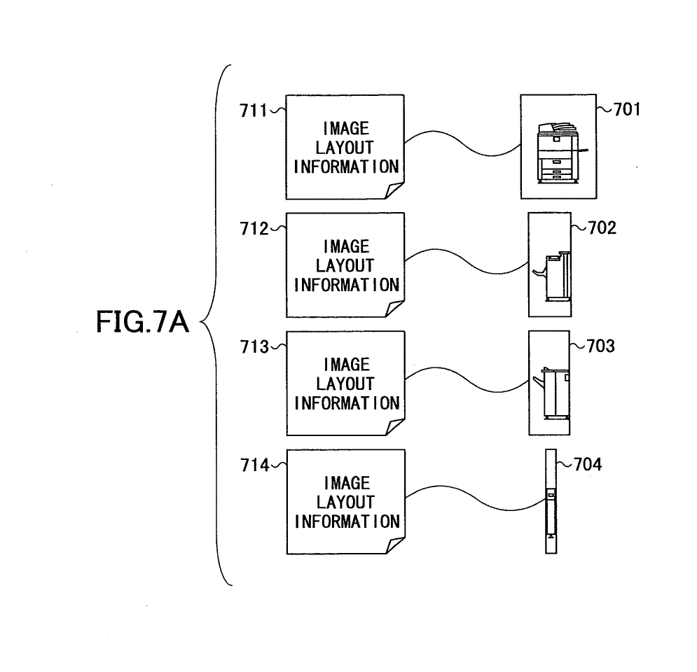

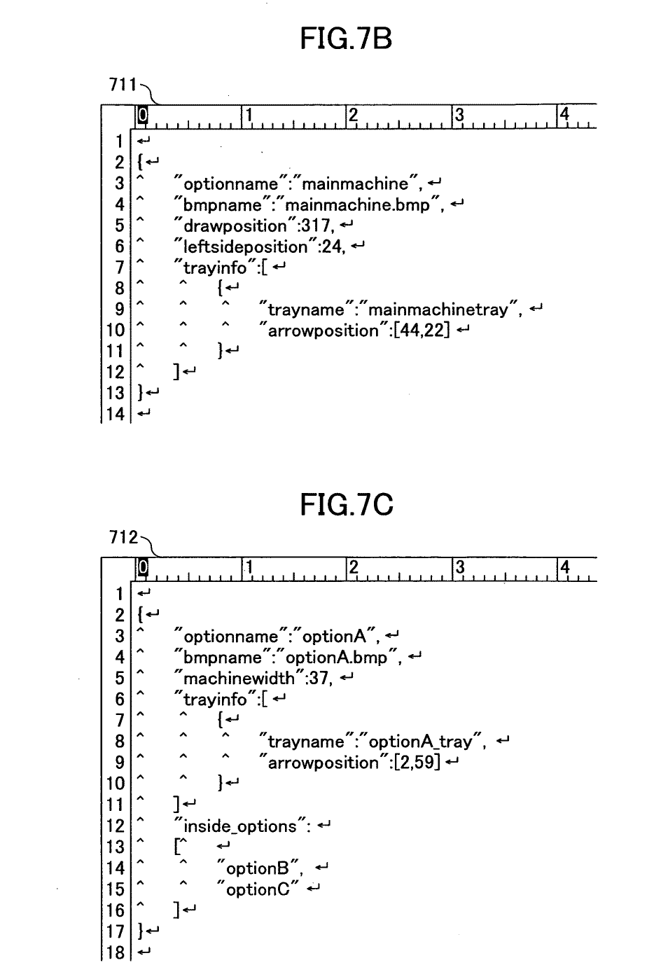

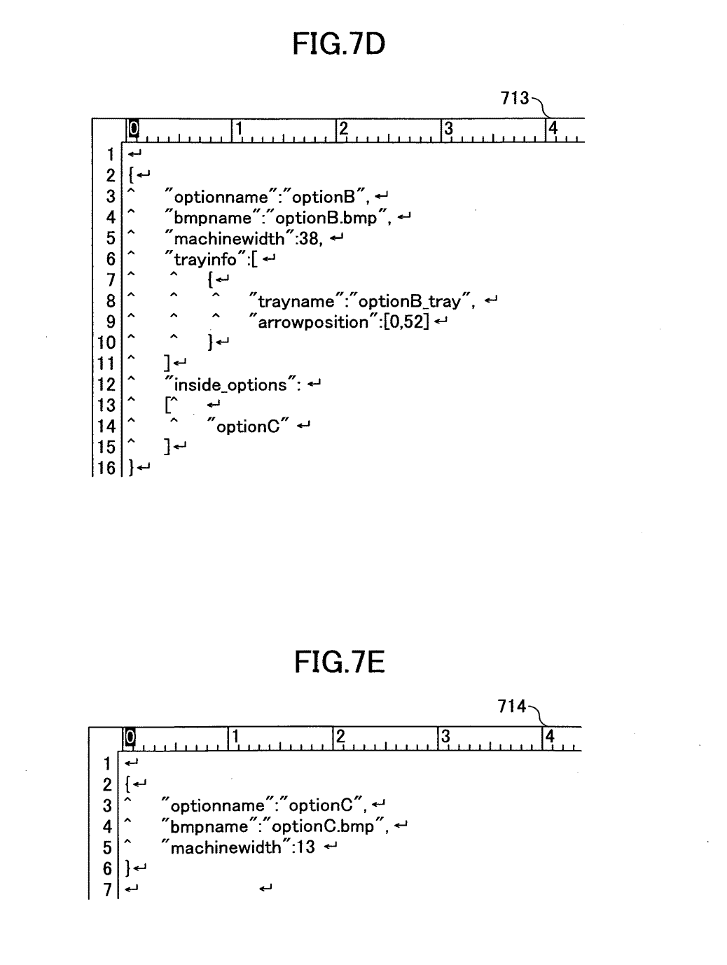

FIGS. 7A through 7E are drawings illustrating a printer image, optional accessory images, and image layout information stored in the storage unit 208. In this example, the storage unit 208 stores a printer image 701, an optional accessory A image 702, an optional accessory B image 703, an optional accessory C image 704, and image layout information 711-714 associated with the corresponding images 701-704. Thus, the storage unit 208 stores image layout information in association with each image. Although not shown in FIGS. 7A through 7E, the storage unit 208 also stores tray-pointing images for pointing at trays.

The image layout information is something like attribute information of an image and is used when drawing a printer configuration image. Details of the image layout information 711-714 are shown in FIGS. 7B through 7E. In this example, the image layout information is implemented as a text file written in JavaScript Object Notation (JSON). However, the image layout information may be expressed in any other format. Details of the printer image, the optional accessory images, and the image layout information are described below. In the descriptions below, it is assumed that the printer image 701, the optional accessory A image 702, the optional accessory B image 703, and the optional accessory C image 704 are stored in the storage unit 208 (i.e., three optional accessories are available). However, the number of optional accessory images stored in the storage unit 208 is not limited to three.

### (Printer Image and Optional Accessory Images

In this embodiment, one printer image is provided for a printer and one optional accessory image is provided for each optional accessory (hereafter, printer and optional accessory images may be simply called “images”). This is because all possible combinations of optional accessories are displayed by combining the optional accessory images. Also in this embodiment, all images have the same height (or length). This makes it possible to eliminate the need to perform calculations to adjust the heights of images during a drawing process. In each optional accessory image (other than the printer image), the right side of the optional accessory coincides with the right edge of the image. Assuming that optional accessories are attached to the left side of a printer as in this example, this makes it easier to draw a printer configuration image by combining printer and optional accessory images. In short, in this embodiment, one image is provided for each device (printer or optional accessory); all images have the same height; and a side of an optional accessory coincides with an edge of its image (this does not apply to the printer image).

### (Image Layout Information)

The image layout information includes the following information items: “device name”, “image name”, “image drawing position in drawing area” (provided only for the printer image), “device position in image”, “intermediate optional accessory information”, and “tray name and drawing position of tray-pointing image”. The above information items are described below with reference to FIGS. 7B through 7E.

In FIGS. 7B through 7E, “device name” is represented by “optionname” and indicates an image (printer image or optional accessory image) associated with the image layout information. For example, in the image layout information 711, “mainmachine” indicating the printer image 701 is specified for “optionname”.

“Image name” is represented by “bmpname” and indicates the name of the corresponding image (printer image or optional accessory image). For example, in the image layout information 711, “mainmachine.bmp” indicating the printer image 701 is specified for “bmpname”.

“Image drawing position in drawing area” is provided only for the printer image and represented by “drawpostion” indicating an x-coordinate of the printer image in the drawing area.

“Device position in image” is represented either by “leftsideposition” or “machinewidth”. The “leftsideposition” parameter is provided only for the printer image and indicates the position of the printer illustrated in the printer image from the left edge of the printer image. For example, “24” specified for “leftsideposition” in the image layout information 711 indicates a distance between the left edge of the printer image and the left side of the printer. The image layout information does not include y-coordinate information. This is because all images have the same height and hence there is no need to adjust the positions of the images in the y-axis direction. The “machinewidth” parameter is provided only for the optional accessory images. The “machinewidth” parameter of an optional accessory image indicates the width of the optional accessory illustrated in the optional accessory image.

“Intermediate optional accessory information” is provided only for the optional accessory images and represented by “inside_options”. “Intermediate optional accessory information” for an optional accessory (image) indicates one or more optional accessories (images) that can be placed between the printer (image) and the optional accessory (image). For example, in the image layout information 712, “optionB” and “optionC” are specified for “inside_options”. This indicates that the optional accessory B and the optional accessory C can be placed between the printer and the optional accessory A.

“Tray name and drawing position of tray-pointing image” is represented by “trayinfo” and indicates the name of a (paper-catch or paper-feed) tray and a position where a tray-pointing image for pointing at the tray is drawn. Two parameters “trayname” and “arrowposition” are provided for “trayinfo”. The “trayname” parameter indicates the name of a tray provided on the corresponding device (printer or optional accessory). For example, in the image layout information 711, “mainmachinetray” is specified for “trayname”. The “arrowposition” parameter indicates coordinates representing a position where a tray-pointing image for pointing at a tray is to be drawn. The origin (0, 0) of the coordinates is set at the upper-left corner of the corresponding device image (printer image or optional accessory image). For example, in the image layout information 711, coordinates “44, 22” are specified for “arrowposition”. When multiple trays are available, multiple sets of “trayname” and “arrowposition” parameters can be specified.

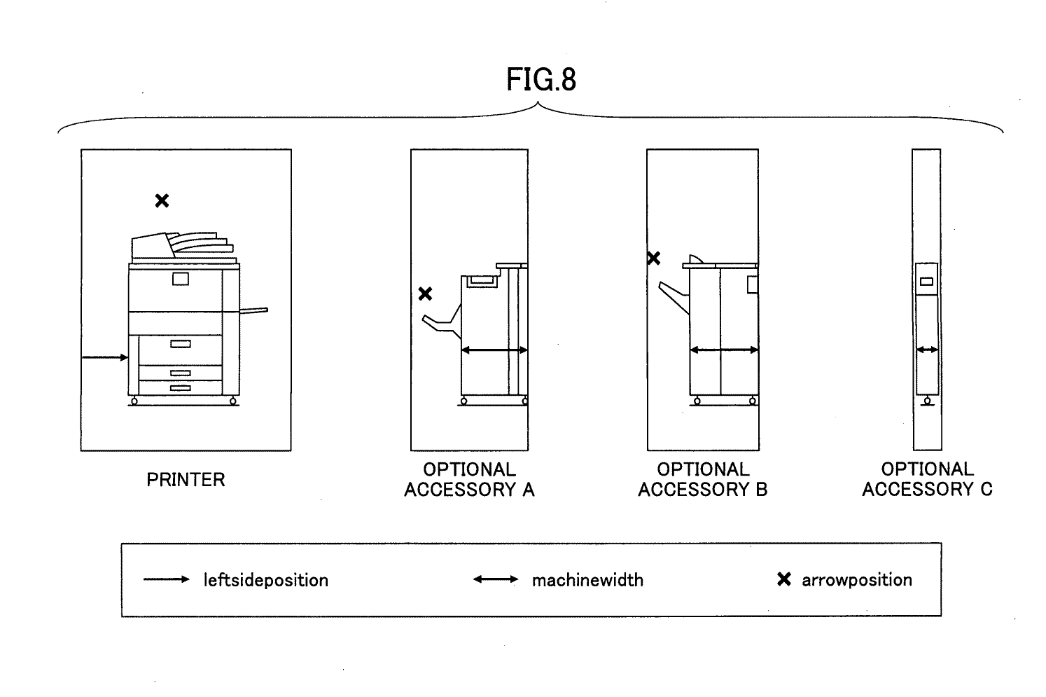

FIG. 8 is a drawing showing examples of information used to determine relative positions of devices illustrated in images. The information used to determine relative positions of devices illustrated in images correspond to “leftsideposition”, “machinewidth”, and “arrowposition” described above. FIG. 8 shows examples of “leftsideposition”, “machinewidth”, and “arrowposition”. Arrows and symbols (e.g., X) shown in FIG. 8 are for descriptive purposes and actual images stored in the storage unit 208 do not include such arrows and symbols.

In short, the following information items are stored in the storage unit 208:
Images illustrating devices (one for each device, i.e., a printer or an optional accessory) and a tray-pointing image(s)
Image layout information used to properly lay out device images (printer image and optional accessory images) relative to each other
Intermediate optional accessory information indicating one or more optional accessories (images) that can be placed between a printer (image) and an optional accessory (image)
A list of one or more trays provided on each device (printer or optional accessory) and information for identifying positions of the trays in the device image (printer image or optional accessory image)

Needless to say, the above described information items and their structures are just examples.

Types and structures of information items to be stored in the storage unit 208 may be determined freely according the method of calculating the layout of images employed by the configuration image drawing unit 210.

### <Processes>

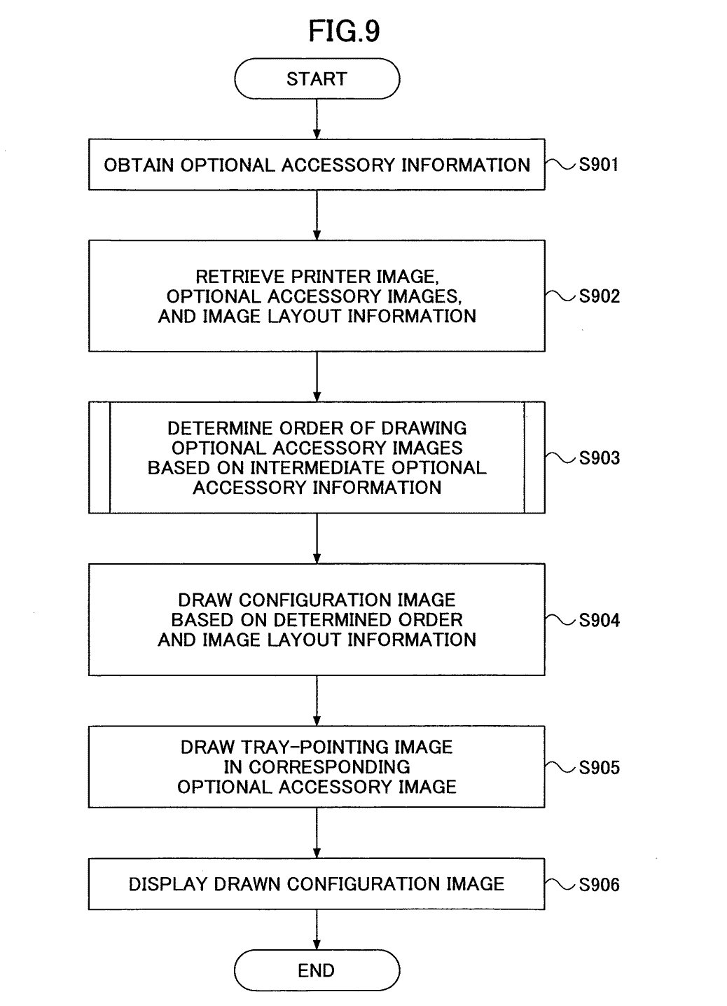

FIG. 9 is a flowchart showing a configuration image display process performed by the PC 1 according to an embodiment of the present invention. The configuration image display process is started when it is necessary to display a configuration image. For example, the configuration image display process is started when the printer properties screen shown in FIG. 1 is opened, when “Options” settings on the printer properties screen are manually changed, or when optional accessory information is obtained from the printer (e.g., when the “Update Now” button is pressed). The configuration image display process is described below with reference to FIG. 9.

In step S901, the optional accessory information obtaining unit 206 obtains optional accessory information including information on optional accessories attached to the printer and information on a tray to be used. For example, the information on optional accessories attached to the printer is obtained via the network 3 from the printer 2. Alternatively, the information on optional accessories attached (or to be attached) to the printer may be obtained from “Options” settings specified manually by the user on the printer properties screen (see FIG. 1). Any other method may also be used to obtain the information on optional accessories attached to the printer. The information on a tray to be used is obtained from a setting specified manually by the user on the printer properties screen (see FIG. 1). This is to allow the user to specify a desired tray on the printer properties screen of PC 1. Accordingly, when the printer properties screen is opened for the first time and the information on optional accessories attached to the printer is obtained via the network 3 from the printer 2, the tray to be used has not been specified and therefore the step of drawing a tray-pointing image (S905 described later) is not performed. In other words, a tray-pointing image may be added to a configuration image when a tray to be used is specified after the configuration image is drawn. However, for descriptive purposes, it is assumed here that the information on a tray to be used has already been obtained. In other words, the rest of the steps are described based on an assumption that the optional accessory information obtaining unit 206 has obtained the information on optional accessories attached to the printer and the information on a tray to be used. Also, it is assumed that optional accessories A, B, and C are attached to the printer and a paper-catch tray of the optional accessory A is to be used.

Referring again to FIG. 9, in step S902, the order determining unit 209 retrieves images of the printer and the optional accessories A, B, and C and their image layout information from the storage unit 208. Here, it is assumed that the order determining unit 209 retrieves the printer image 701, the optional accessory A image 702, the optional accessory B image 703, the optional accessory C image 704, and the image layout information 711-714 associated with the images 701-704 shown in FIGS. 7A through 7E.

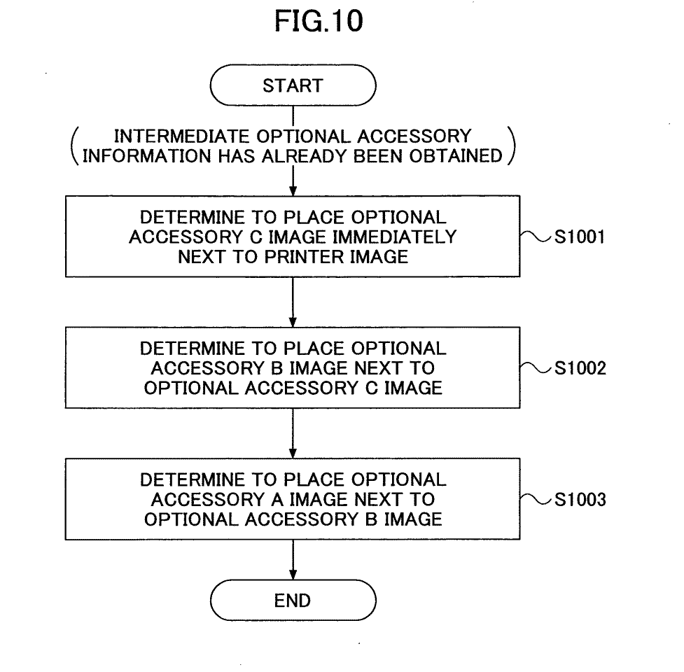

In step S903, the order determining unit 209 determines the order of drawing the optional accessory images 702-704 based on their intermediate optional accessory information. This step is described in more detail below. FIG. 10 is a flowchart showing a process of determining the order of drawing optional accessory images based on intermediate optional accessory information.

In step S1001 of FIG. 10, the order determining unit 209 determines to place the optional accessory C image 702 at a position immediately next to the printer image 701. More specifically, the order determining unit 209 refers to the image layout information of each of the optional accessory images 702-704 and selects one of the optional accessory images 702-704 the image layout information of which does not include intermediate optional accessory information (i.e., to find an optional accessory between itself and the printer no other optional accessory can be placed). The selected optional accessory image is placed next to the printer image. In this example, the optional accessory C image 704 is placed at a position immediately next to the printer image 701.

In step S1002, the order determining unit 209 determines to place the optional accessory B image 703 at a position next to the optional accessory C image 704. More specifically, the order determining unit 209 refers to intermediate optional accessory information of each of the optional accessory images 703-704, determines that the optional accessory A image 702 cannot be placed between the optional accessory B image 703 and the printer image 701, and therefore places the optional accessory B image 703 next to the optional accessory C image 704. Alternatively, the order determining unit 209 may be configured to arrange optional accessory images in ascending order of the number of optional accessories that can be placed between the printer and each optional accessory.

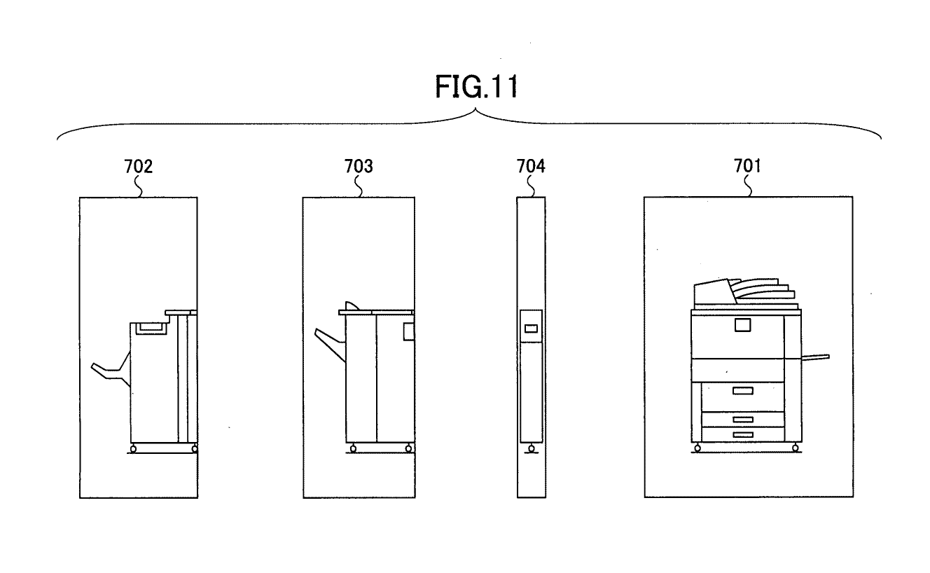

In step S1003, the order determining unit 209 determines to place the optional accessory A image 702 at a position next to the optional accessory B image 703. Thus, the printer image 701, the optional accessory C image 704, the optional accessory B image 703, and the optional accessory A image 702 are arranged in the order as shown in FIG. 11.

The order of images is uniquely determined based on the intermediate optional accessory information. As described above, the intermediate optional accessory information defines optional accessories that can be placed between the printer and the corresponding optional accessory based on functional characteristics of the optional accessories. Here, it is necessary to define the intermediate optional accessory information such that the order of optional accessories (or images) can be uniquely determined even if both the optional accessory A and the optional accessory B can be placed at a position furthest from the printer. More particularly, it is necessary to define the intermediate optional accessory information such that the order of optional accessories (or images) can be uniquely determined even when the following two types of orders are possible: optional accessory A-optional accessory B-optional accessory C-printer; and optional accessory B-optional accessory A—optional accessory C-printer. For this reason, the intermediate optional accessory information for the optional accessory B (image) does not include the optional accessory A.

In step S904 of FIG. 9, the configuration image drawing unit 210 draws a configuration image based on the determined order of images and the image layout information. This drawing step is described in more detail below with reference to relevant drawings.

(1) Calculation of Drawing Position of Printer Image in Drawing Area

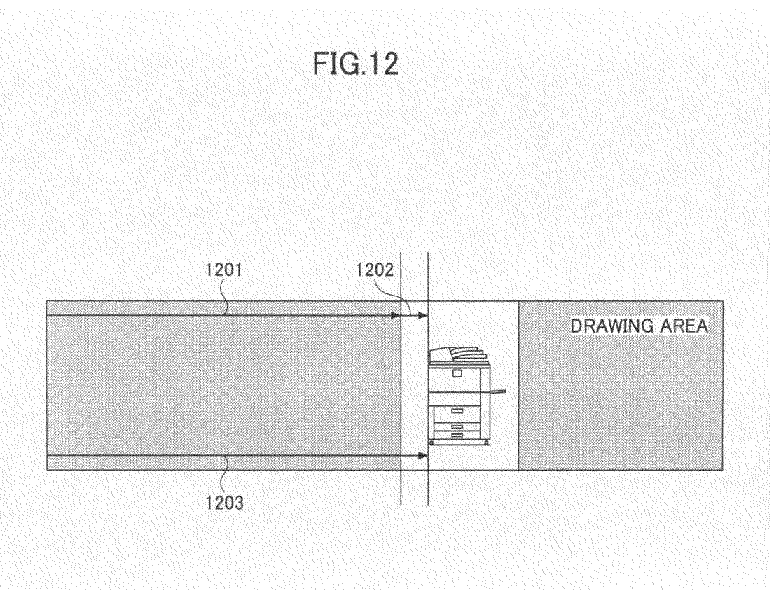

The drawing area is an area where a configuration image can be drawn. First, the configuration image drawing unit 210 calculates the drawing position of the printer image 701 in the drawing area by referring to “drawposition” and “leftsideposition” in the image layout information 711. FIG. 12 is a drawing showing the drawing area where the printer image 701 is drawn. In FIG. 12, “drawposition” 1201 indicates the drawing position of the printer image 701 from the left end of the drawing area, and “leftsideposition” 1202 indicates a distance between the left edge of the printer image 701 and the left side of the printer illustrated in the printer image 701. In this example, the “drawposition” 1201 is “317” and the “leftsideposition” 1202 is “24”. Therefore, a left-side position 1203 of the printer drawn in the drawing area is represented by an x-coordinate=341.

The “drawposition” is provided to draw the printer in the middle of the drawing area. Since optional accessories may be attached to the right side of the printer in addition to the left side, the “drawposition” is determined such that a certain amount of drawing space is also reserved to the right of the printer in the drawing area. Also, information indicating a right-side margin (e.g., “rightsideposition”) may be added to the image layout information. In this example, for descriptive purposes, it is assumed that optional accessories are attached only to the left side of the printer.

(2) Calculation of Drawing Positions of Optional Accessory Images

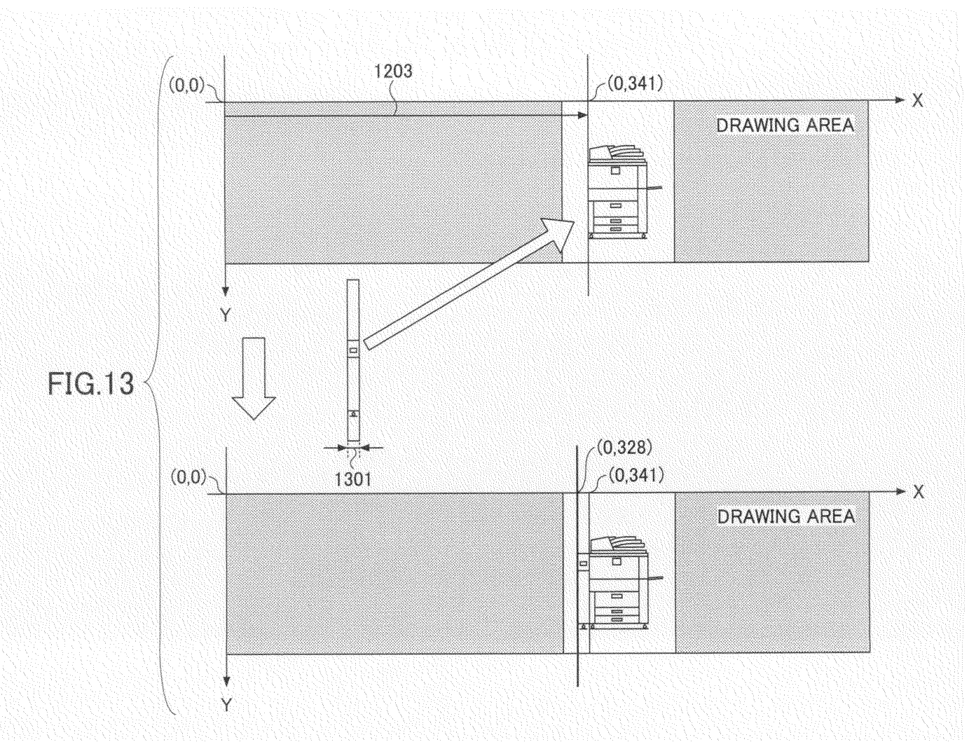

Next, the configuration image drawing unit 210 calculates drawing positions of optional accessory images. Based on the determined order, the configuration image drawing unit 210 first calculates the drawing position of the optional accessory C image 704 by referring to “machinewidth” in the image layout information 714. FIG. 13 is a drawing showing the drawing area where the optional accessory C image 704 is drawn. In FIG. 13, “machinewidth” 1301 indicates the width of the optional accessory C illustrated in the optional accessory C image 704. The configuration image drawing unit 210 draws the optional accessory C image 704 from the left-side position (x-coordinate=341) of the printer in the drawing area. In this example, the “machinewidth” 1301 is and therefore the left-side position of the drawn optional accessory C in the drawing area is represented by an x-coordinate=328. The x-coordinate=328 is used as the base point of the next optional accessory B image 703.

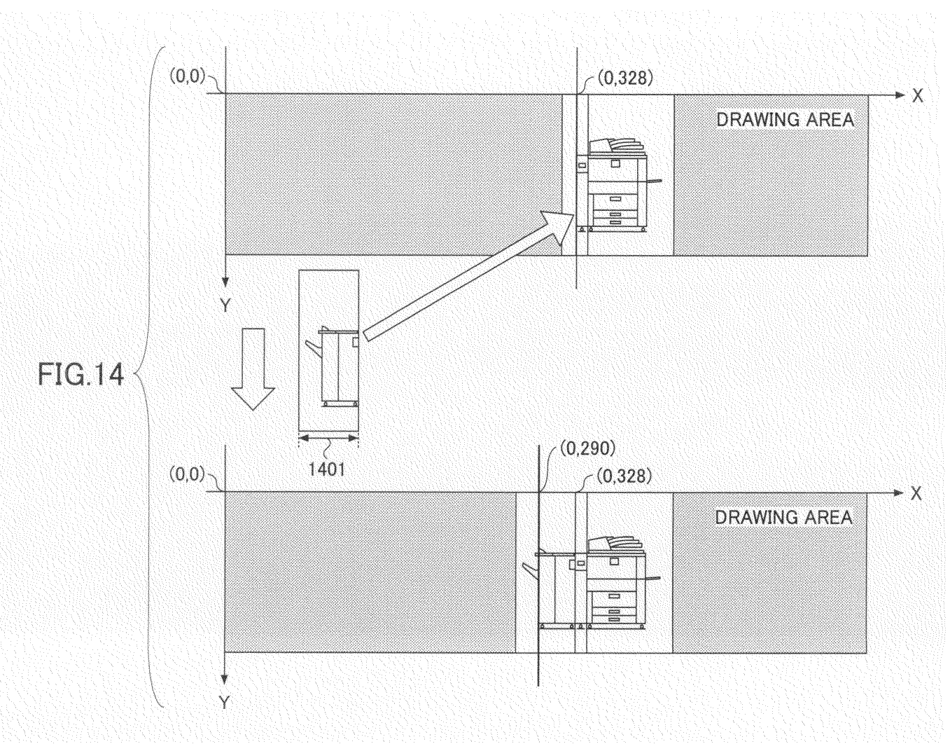

Similarly, the configuration image drawing unit 210 calculates the drawing position of the optional accessory B image 703 by referring to “machinewidth” in the image layout information 713. FIG. 14 is a drawing showing the drawing area where the optional accessory B image 703 is drawn. In FIG. 14, “machinewidth” 1401 indicates the width of the optional accessory B illustrated in the optional accessory B image 703. The configuration image drawing unit 210 draws the optional accessory B image 703 from the left-side position (x-coordinate=328) of the optional accessory C in the drawing area. In this example, the “machinewidth” 1401 is 38 and therefore the left-side position of the drawn optional accessory C in the drawing area is represented by an x-coordinate=290. The x-coordinate=290 is used as the base point of the next optional accessory A image 702.

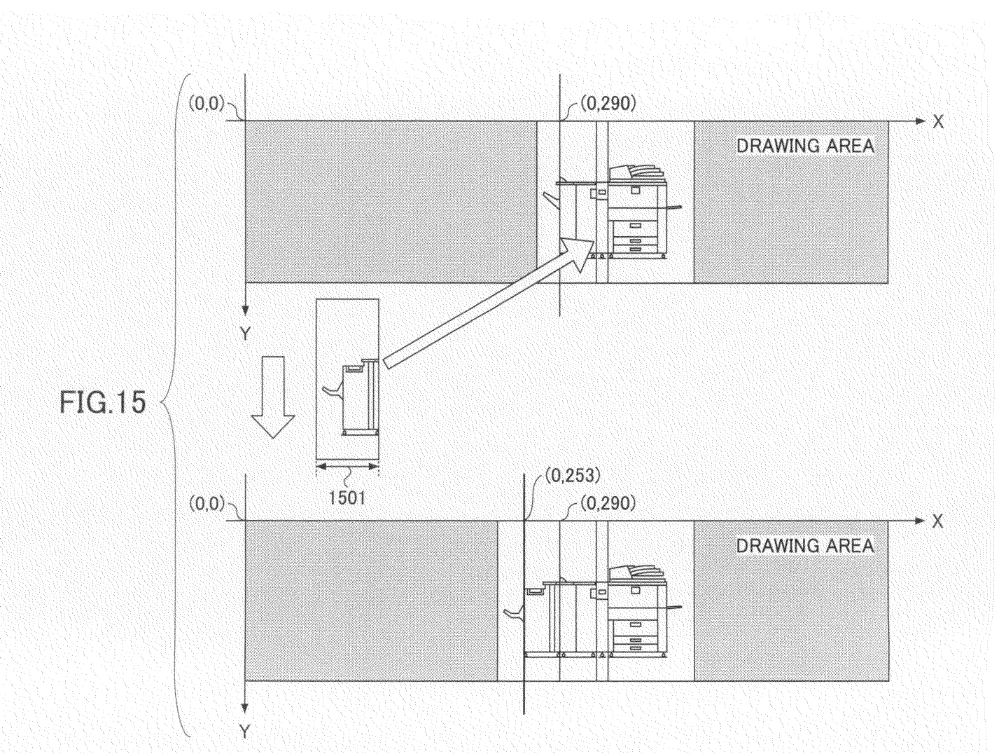

Next, the configuration image drawing unit 210 calculates the drawing position of the optional accessory A image 702 by referring to “machinewidth” in the image layout information 712. FIG. 15 is a drawing showing the drawing area where the optional accessory A image 702 is drawn. In FIG. 15, “machinewidth” 1501 indicates the width of the optional accessory A illustrated in the optional accessory A image 702. The configuration image drawing unit 210 draws the optional accessory A image 702 from the left-side position (x-coordinate=290) of the optional accessory B in the drawing area. In this example, the “machinewidth” 1501 is 37 and therefore the left-side position of the drawn optional accessory A in the drawing area is represented by an x-coordinate=253. Through the above process, the printer image 701, the optional accessory C image 704, the optional accessory B image 703, and the optional accessory A image 702 are drawn as shown in the lower part of FIG. 15.

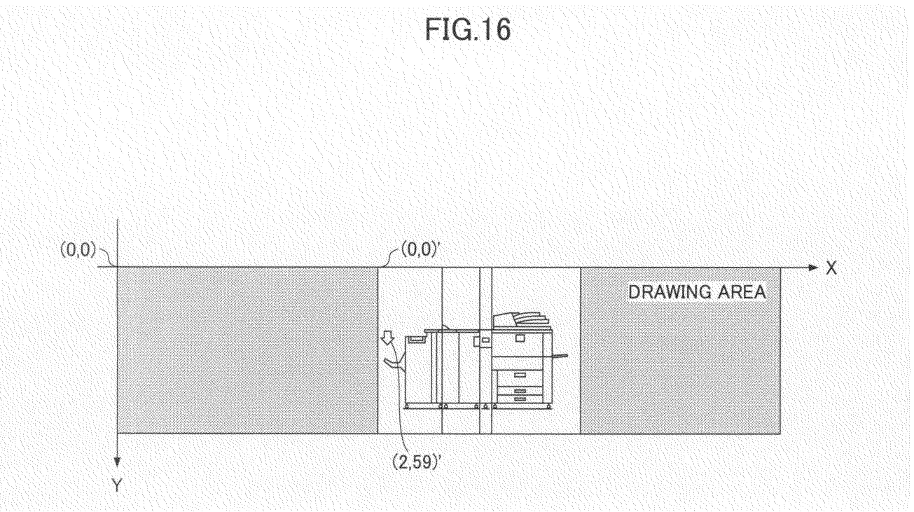

In step S905 of FIG. 9, the configuration image drawing unit 210 draws a tray-pointing image in an optional accessory image. Here, it is assumed that a tray provided on the optional accessory A is to be used. Therefore, the configuration image drawing unit 210 draws a tray-pointing image (e.g., an arrow image) in the optional accessory A image 702. FIG. 16 is a drawing showing a tray-pointing image drawn in the optional accessory A image 702. In this example, the configuration image drawing unit 210 refers to the image layout information 712 corresponding to the optional accessory A image 702, and draws a tray-pointing image (arrow image) having a name specified by “trayname” in a position indicated by “arrowposition”. In FIG. 16, the tray-pointing image is drawn in a position indicated by coordinates (2, 59)′ with the origin (0, 0)′ at the upper-left corner of the optional accessory A image 702. If no tray-pointing image is to be drawn, step S905 may be omitted. As described above, the information on a tray to be used is obtained from a setting specified manually by the user on the printer properties screen (see FIG. 1). If the setting on a tray to be used is not specified, step S905 is not performed.

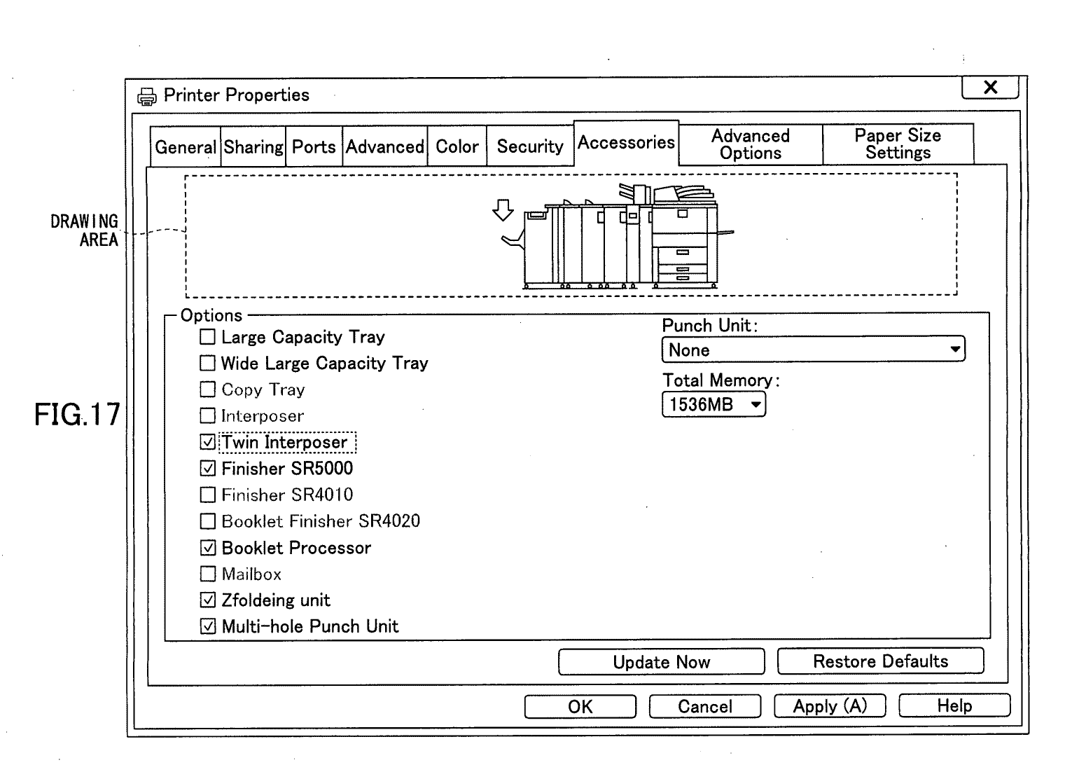

In step S906 of FIG. 9, the configuration image display unit 211 displays the printer configuration image drawn by the configuration image drawing unit 210. For example, the configuration image display unit 211 displays the printer configuration image on the printer properties screen (print setting screen). FIG. 17 is a drawing illustrating an exemplary printer properties screen where the drawn printer configuration image is displayed. In this example, a display area for displaying the printer configuration image coincides with the drawing area.

### <Summary>

In the above embodiment, a printer driver program and a computer (PC 1) that provides various functions by executing the printer driver program are described. As described above, a printer driver may include a function to visually display a printer configuration (printer configuration image) including attached optional accessories to improve user-friendliness. Optional accessories may be attached to a printer in various combinations. For this reason, in related-art technologies, a printer driver for a printer generally includes printer configuration images corresponding to all possible combinations of optional accessories that can be attached to the printer. However, with the related-art technologies, the amount of necessary information increases exponentially as the number of possible combinations of optional accessories increases, and this in turn increases the workload of a developer in preparing printer configuration images and coordinate information.

A printer driver according to an aspect of the present invention includes one optional accessory image for each optional accessory and can draw printer configuration images corresponding to all possible combinations of optional accessories by combining the optional accessory images according to image layout information. With this approach, when a new optional accessory becomes available for a printer, the developer can provide an upgraded printer driver by just adding an image for the new optional accessory and updating image layout information. Thus, an aspect of the present invention makes it possible to reduce the workload of a printer driver developer and to reduce the amount of information (data) to be included in a printer driver.

In other words, aspects of the present invention provide a printer driver program, an information processing apparatus, and a storage medium storing the printer driver program that make it possible to efficiently draw and display a printer configuration including optional accessories.

A printer driver according to an aspect of the present invention obtains optional accessory information about optional accessories attached to a printer through communication with the printer or from settings specified manually by the user, and draws and displays a printer configuration image based on the obtained optional accessory information.

The above described embodiments may also be applied to a method, a system, a computer program, and a storage medium storing the computer program.

The present invention is not limited to the specifically disclosed embodiments, and variations and modifications may be made without departing from the scope of the present invention.

The present application is based on Japanese Priority Application No. 2009-005085, filed on Jan. 13, 2009, the entire contents of which are hereby incorporated herein by reference.

What is claimed is:

1. A computer-readable storage medium having a printer driver program stored therein for causing a computer to draw and display a printer configuration image showing a printer configuration including a printer and optional accessories attached to the printer, the printer driver program comprising:
an optional accessory information obtaining code unit configured to obtain optional accessory information on the optional accessories attached to the printer;
a storage code unit configured to store a printer image of the printer, optional accessory images corresponding one-to-one to the optional accessories, and image layout information including intermediate optional accessory information provided for each of the optional accessories and indicating optional accessories placeable between each of the optional accessories and the printer;
an order determining code unit configured to determine an order of drawing the optional accessory images in a direction away from the printer based on the optional accessory information and the intermediate optional accessory information; and
a configuration image drawing code unit configured to draw the printer configuration image by arranging the optional accessory images relative to the printer image according to the determined order and the image layout information.

2. The storage medium as claimed in claim 1, wherein
the optional accessory information obtaining code unit is configured to further obtain tray information on a tray to be used;
the storage code unit further stores a tray-pointing image for pointing at the tray;
the image layout information further includes tray position information indicating positions of trays provided on the optional accessories; and
the configuration image drawing code unit is configured to draw the tray-pointing image in the printer configuration image based on the tray information and the tray position information.

3. An information processing apparatus for drawing and displaying a printer configuration image showing a printer configuration including a printer and optional accessories attached to the printer, the information processing apparatus comprising:
an optional accessory information obtaining unit configured to obtain optional accessory information on the optional accessories attached to the printer;
a storage unit configured to store a printer image of the printer, optional accessory images corresponding one-to-one to the optional accessories, and image layout information including intermediate optional accessory information provided for each of the optional accessories and indicating optional accessories placeable between each of the optional accessories and the printer;
an order determining unit configured to determine an order of drawing the optional accessory images in a direction away from the printer based on the optional accessory information and the intermediate optional accessory information; and
a configuration image drawing unit configured to draw the printer configuration image by arranging the optional accessory images relative to the printer image according to the determined order and the image layout information.

4. The information processing apparatus as claimed in claim 3, wherein
the optional accessory information obtaining unit is configured to further obtain tray information on a tray to be used;
the storage unit further stores a tray-pointing image for pointing at the tray;
the image layout information further includes tray position information indicating positions of trays provided on the optional accessories; and
the configuration image drawing unit is configured to draw the tray-pointing image in the printer configuration image based on the tray information and the tray position information.
